(19) United States
(12) Patent Application Publication
(10) Pub. No.: US 2004/0264097 A1
(43) Pub. Date: Dec. 30, 2004

(54) Anti-static device for clothes, clothes dryers

(76) Inventors: Gary D. Babbitt, Boise, ID (US); Fred E. Chapman, Boise, ID (US); Howard E. King, Boise, ID (US); Richard E. Yetsko, Boise, ID (US)

Correspondence Address: Gary D. Babbitt, P.O. Box 1617, Boise, ID, 83701, US

(21) Appl. No.: 10/609,098

(22) Filed: Jun. 27, 2003

(51) Int. Cl. H02H 1/00

(52) U.S. Cl. 361/212

(57) ABSTRACT

This describes a portable non-pressurized, non-toxic, and non-liquid anti-static device for eliminating static cling on clothes on which static electricity has built up. A portable electrical conductive device is placed next to clothes worn by a person or placed in a clothes dryer to induce electrical current flow from the clothes to dissipate static electricity therein and improve anti-static protection.

### BACKGROUND OF THE INVENTION INVENTION DISCLOSURE STATEMENT BY APPLICANT

No patent ability search has been conducted on this disclosure. Applicant knows of no prior art more pertinent than disclosed this application. Further, Applicant knows of no portable solid, non-chemical, non-pressurized anti-static device.

### BACKGROUND OF THE INVENTION

This invention relates to the removal of anti-static electricity from clothing. More particularly, it relates to a portable anti-static device.

Static electricity build-up on clothing is a major inconvenience in wearing clothing or drying clothing. The static build-up is especially prevalent in cold, dry weather. The static electricity build-up is especially noticeable on many materials, including wool and some manmade fibers.

When clothes are dried in a rotary clothes dryer, the tumbling action of the clothes causes the build-up of static electricity which creates appreciable charges of static electricity in the clothes.

The static electricity is of opposite charges and therefore the clothes tend to stick together making it difficult to separate the clothes upon removal from the clothes dryer.

When static electricity builds up on clothing worn by a person, it can cause embarrassing situations for the wearer of the clothing. It is not uncommon for clothing to cling to certain parts of the human body and expose other parts, preventing the clothing from hanging in their natural tailored position.

Many of the static protective devices known in the art dissipate an electrical charge-generated by a person to a ground, see for example the following U.S. Patents:

U.S. Pat. No. 4,398,277 to Christiansen, et al.

U.S. Pat. No. 4,373,175 to Mykkanen;

U.S. Pat. No. 3,857,397 to Brosseau;

U.S. Pat. No. 3,596,134 to Burke;

U.S. Pat. No. 3,084,700 to Fisher, et al.;

U.S. Pat. No. 1,940,491 to Freitag; and

U.S. Pat. No. 4,680,668 to Belkin.

Other devices, such as magnets, have been placed within clothes dryers to create magnetic fields to neutralize the electrostatic charges in clothes. Such devices are disclosed in U.S. Pat. No. 3,991,479 and U.S. Pat. No. 3,161,479.

Other anti-static devices are attached to the tumbling veins of rotary dryers in a manner to induce electrical current flow in the tumbling clothes in U.S. Pat. No. 4,190,874 to Pasold.

Prior art reveals devices for use in a laundry to eliminate static electricity cling by neutralizing static electricity build-up during the drying process. It is known in prior art to use fabric conditioning devices comprising a thin polyurethane foam substrate impregnated with a conditioning agent, which substrate is fabricated such that the agent is entrapped or entrained within the cellular structure of the foam and dispensed during a single cycle. An example of such a device is available from Beecham, Inc. and sold under the trademark Cling Free.R™., as dryer-added fabric softener and an anti-static device which is commingled with the laundry articles. A further example is U.S. Pat. No. 4,460,644 issued to Pavlic, which discloses a fabric conditioning device for use in an automatic dryer which comprises a polyurethane foam substrate impregnated with or coated with an effective amount of fabric conditioning agent. Finally, U.S. Pat. No. 5,966,831 describes an anti-static device comprising a three-dimensional body with a polyurethane foam carrier, impregnated by at least one liquid substance, preferably an ion-containing anti-static agent. The anti-static agent is released in a controlled manner over multiple drying cycles as the foam carrier is exposed to impact and heat.

Static electricity is created through the process of friction, by inducing opposite electrical charges between the frictional pieces. When two non-conducting materials come in contact with the other, a chemical bond, known as adhesion, is formed between the two materials. Depending on the triboelectric properties of the materials, one material may capture some of the electrons from the other. When the two materials are separated, the material which captured the electron is now negatively charged and the material that lost an electron is now positively charged. The charge imbalance causes a phenomenon commonly called “static electricity.” This static electricity makes it difficult to separate clothes upon removal from the clothes dryer. Static electrical charges are not known to be harmful, but they are a common and troubling problem. It is highly desirable to provide a member of neutralizing, static charges before the clothes are removed from the dryer.

The background art devices are limited to the use of magnets, attachments to dryers, and the use of chemicals. There exists a need for a device for use in a: laundry dryer or which is portable with a person to prevent the build-up of static cling in clothes in a clothes dryer, as well as when the clothes are being worn.

### SUMMARY OF THE INVENTION

This is a portable, anti-static device for eliminating electric static in clothing. The present invention either employs chemicals or cumbersome attachments. The present invention is inexhaustible and may be reused repeatedly. Unlike chemical anti-static agents which may not be used in clothes dryers with children's clothing which are treated with a flame-resistant or flame-retardant products, the present invention may be safely used with all types of natural and manmade fibers.

Past devices such as magnets have been placed within the clothes dryer so that the magnetic field will neutralize the static charges in the clothes. The magnetic field causes electrical currents to be induced within the clothes, thereby neutralizing static charges. Such a device is disclosed in U.S. Pat. No. 3,991,479. Other patents, such as U.S. Pat. No. 3,161,479, disclose circuitry with provides an electrical pickup physically connected to a grounding element. Many static-protective devices known in the art dissipate an electrical charge generated by a person to a ground. See, for example, the following U.S. patents:

U.S. Pat. No. 4,398,277 to Christiansen, et al.;

U.S. Pat. No. 4,373,175 to Mykkanen;

U.S. Pat. No. 4,190,874 to Pasvold;

U.S. Pat. No. 3,857,397 to Brosseau;

U.S. Pat. No. 3,349,285 to Gambetti;

U.S. Pat. No. 3,596,134 to Burke;

U.S. Pat. No. 4,680,6688 to Belkin,

U.S. Pat. No. 3,084,700 to Fischer, et al.;

U.S. Pat. No. 1,940,491 to Freitag;

U.S. Pat. No. 2,568,068 to Harpman; and

U.S. Pat. No. 2,975,528 to Shewmon.

Other prior art includes anti-static agents comprising various chemical compounds:

U.S. Pat. No. 4,025,444 to Murphy;

U.S. Pat. No. 4,110,498 to Benjamin;

U.S. Pat. No. 4,118,525 to Jones;

U.S. Pat. No. 4,642,258 to Majewski;

U.S. Pat. No. 5,145,595 to Morris; and

U.S. Pat. No. 5,726,143 to Petraia.

In the preferred embodiment, the device comprises a three-dimensional body having a core material which captures static electricity, wrapped with a conductive metal wire which conducts electrostatic energy to the core of the device. Each end of the present invention is covered with a cap composed of synthetic material to prevent the device from snagging or catching on clothing.

It is an object of the present invention to provide an article for use with automatic laundry dryers which eliminates static electric energy.

It is an object of this invention to provide a device which captures and thereby neutralizes static electricity from a garment which is being worn.

It is still a further object of this invention to provide a device which is simple in construction and inexpensive.

It is a further object of this invention to provide a device for eliminating static electricity without employing chemicals, magnets, or grounding devices.

Still another object of the present invention is to provide a device that is capable of substantial repeated use without the need for disposal, refill or recharge.

It is yet another object of the present invention to provide a device which may be used with all types of natural and manmade fibers.

In accordance with these and other objects which become apparent hereinafter, the present invention will now be described with particular reference to the accompanying drawings.

### BRIEF DESCRIPTION OF THE DRAWINGS

FIG. 1 is a side prospective view of the preferred embody of the present invention.

FIG. 2 is a cross-section of the present invention at a 45° angle.

FIG. 3 is a side view of the present invention with the end cushion caps removed.

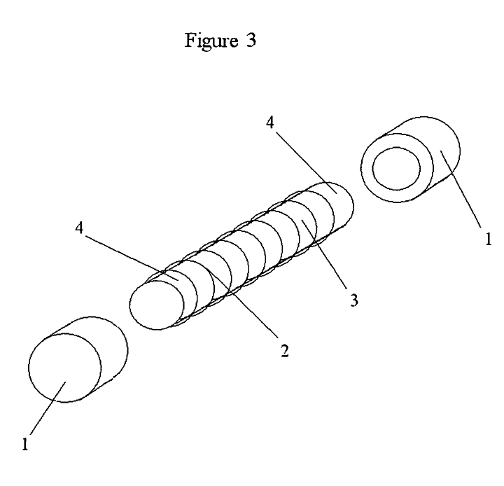

### DESCRIPTION OF THE PREFERRED EMBODIMENT

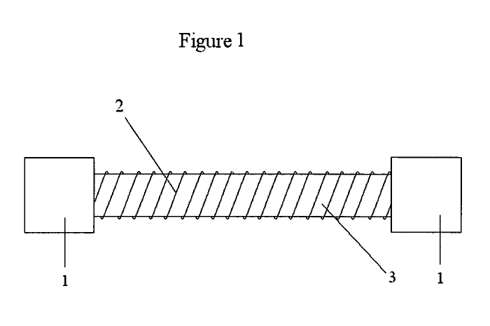

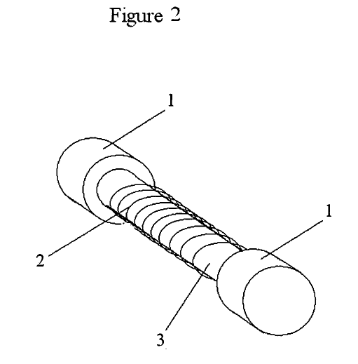

The preferred embodiment is shown in FIGS. 1 and 2. Although other embodiments can be used with equal effectiveness, FIG. 1 shows the present invention with a core member 3 which has a capacity to collect or capture static electricity comprised of “TEFLON.R™.” which is commercially available. The core member 3 can be any material which has a capacity to absorb, collect or capture triboelectrical charges. The core member is surrounded by a metal wire 2 or composite material having the capacity to conduct static electrical charges. In the preferred embodiment, copper wire 2 is wrapped snuggly around the core member 3.

The device described above in FIG. 1 shows that the ends of the core member are covered with cushioning caps 1 which are securely attached to the device by glue or epoxy resin. The caps 1 fit over the metal wire 2 and the core material 3. The epoxy resin is placed on the ends of the device 4 and the caps 1 are thereby fitted securely over the wire 2 and core member 3. The preferred metal wire is from the group of metal having the highest conductivity such as gold, silver, copper and aluminum.

For cost efficiency the preferred embodiment uses conductive wire 2 made of aluminum.

This anti-static device FIG. 1 is portable and can be placed in a garment pocket or carried in a purse. When one's clothing has electrostatic electricity cling, a person would take out the anti-static device and simply manipulate it over the clothing to remove the electrostatic cling.

In another very practical use, the anti-static device FIG. 1 is simply placed in the laundry clothes dryer and allowed to tumble freely with the clothes. The clothes come in contact with the copper, wire 2 and the core material 3, TEFLON.R™ which collects and captures the electrostatic charge.

When the antic-static device FIG. 1 is used either by a person on their clothing or placed in a laundry clothes dryer, there is avoided the possibility of any chemicals resulting in spotting or staining a person's clothing. Furthermore, the anti-static device FIG. 1 may be safely used repetitively. When the need for the use of the anti-static device FIG. 1 is no longer desired it may be placed in storage or simply placed in a pocket or handbag. The anti-static device FIG. 1 does not employ any aerosols, vapors or chemicals of any kind.

While the invention has been described with a certain degree of particularity, it is manifest that many changes may be made in the details of the construction without departing from the spirit and scope of this disclosure. It is understood that the invention is not limited to the embodiments sent forth herein for purpose of exemplification, but is to be limited only by the scope of the attached claim or claims, including the full range of equivalency to which each element thereof is entitled.

We claim as patent:

1. A portable device for reducing static electricity in clothing comprising:
a. a flexible member for conducting static electricity substantially surrounding an elongated sturdy member for capturing static electricity, and
b. a means for attaching said flexible conducting member to said rigid capturing member comprising a predetermined adhesive material substantially covering the end portions of said rigid capturing member, whereby the flexible conducting member is fixably attached to said rigid capturing member.

2. The device in claim 1 wherein said conducting member is metal with predetermined conductivity.

3. The device in claim 1 wherein said conducting member is a composite material having predetermined conductivity.

4. The device in claim 1 wherein said conducting member is a metal wire having predetermined conductivity.

5. The device in claim 1 wherein said capturing member comprises Teflon.R™.

6. The device in claim 1 wherein said capturing member is selected from the group consisting of silicon, vinyl, polyprolene, polyurethane, Saran.R™, styrene, and polyester, whereby electrical charges from clothing are captured.

7. The device in claim 1 comprising an anti-snag member attached to, each end of said elongated capturing member, whereby the device is prevented from snagging clothing.

8. The device in claim 1 comprising a cushioning member attached to each end of said elongated capturing member, whereby said conducting member and capturing member are prevented from contacting the dryer drum or snagging clothing.

9. A portable device for reducing static electricity in clothes in a laundry clothes dryer comprising:
a. a flexible member for conducting static electricity substantially surround an elongated sturdy member for capturing static electricity, and
b. a means for attaching said flexible conducting member to said rigid capturing member comprising a predetermined adhesive material substantially covering the end portions of said rigid capturing member, whereby the flexible conducting member is fixably attached to said rigid capturing member.

10. The device in claim 9 wherein said conducting member is metal with predetermined conductivity.

11. The device in claim 9 wherein said conducting member is a composite material having predetermined conductivity.

12. The device in claim 9 wherein said conducting member is metal with predetermined conductivity.

13. The device in claim 9 wherein said conducting member is a composite material having predetermined conductivity.

14. The device in claim 9 wherein said conducting member is a metal wire having predetermined conductivity.

15. The device in claim 9 wherein said capturing member comprises Teflon.R™.

16. The device in claims 9 wherein said capturing member is selected from the group consisting of silicon, vinyl, polyprolene, polyurethane, Saran.R™, styrene, and polyester, whereby electrical charges from clothing are captured.

17. The device in claim 9 comprising an anti-snag member attached to each end of said capturing member, whereby the device is prevented from snagging clothing.

18. The device in claim 9 comprising a cushioning member attached to each end of said elongated capturing member, whereby the device is prevented from contacting the dryer drum or snagging clothing.
